(19) United States
(12) Patent Application Publication
(10) Pub. No.: US 2011/0093202 A1
(43) Pub. Date: Apr. 21, 2011

(54) SYSTEMS AND METHODS FOR MONITORING AND DETECTING AN EVENT

(76) Inventor: Carl THOMPSON, Broomfield, CO (US)

(21) Appl. No.: 12/580,549

(22) Filed: Oct. 16, 2009

(51) Int. Cl. G01V 1/24; G01V 1/28

(52) U.S. Cl. 702/14

(57) ABSTRACT

A system for monitoring and detecting an event. A position determining unit configured to receive a position determining signal. A seismic event detector configured to detect a seismic event and generate a seismic event signal. A storage unit configured for storing position information corresponding to the position determining signal, the storage of the position information occurs in a first manner. A storage unit manager configured to alter the first manner of the storing the position information upon a receipt of the seismic event signal.

### BACKGROUND

A seismic event, including an earthquake, is a release of energy in the Earth's crust. Such an event may include shifting, shaking and displacement of the Earth's crust and may generate seismic waves. Seismic events may also be associated with other events such as tsunamis, landslides and volcanic activities. These events may have great impact on human lives including an effect on both natural and man-made structures. Therefore it is desirable to track and record information related to such seismic events and to improve the information to support further analysis.

Systems have been established to determine the location of a receiver on the Earth's surface by receiving signals from a plurality of transmitters in the system. Receivers are becoming increasingly accurate in determining their location on the surface of the Earth.

### BRIEF DESCRIPTION OF THE DRAWINGS

The accompanying drawings, which are incorporated in and form a part of this application, illustrate various embodiments of the presented technology, and together with the description of embodiments, serve to explain the principles of the presented technology. Unless noted, the drawings referred to this description should be understood as not being drawn to scale.

FIG. 1 is a block diagram of an example system for monitoring and detecting an event, in accordance with an embodiment.

FIG. 2 is a graph of an event, in accordance with an embodiment.

FIG. 3 is a flowchart of a method for monitoring and detecting an event in accordance with embodiments of the present invention.

FIG. 4 illustrates a diagram of an example computer system to be used with various embodiments of the present technology.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

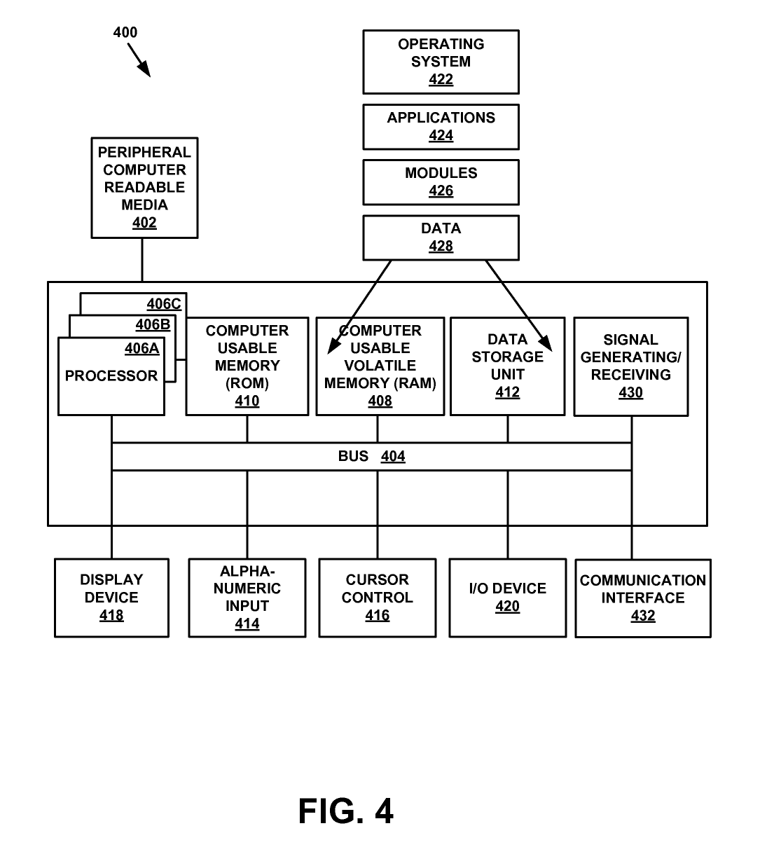

Unless specifically stated otherwise as apparent from the following discussions, it is appreciated that throughout the present Description of Embodiments, discussions utilizing terms such as “receiving,” “storing,” “detecting,” “generating,” “altering,” “transmitting,” or the like, refer to the actions and processes of a computer system (such as computer system 400 of FIG. 4), or similar electronic computing device. Computer system 400 or similar electronic computing device manipulates and transforms data represented as physical (electronic) quantities within the computer system's registers and memories into other data similarly represented as physical quantities within the computer system memories or registers or other such information storage, transmission, or display devices.

The subject matter discussed herein may be described in the general context of computer-executable instructions, such as modules, which are executed or executable by a computer. Generally, these modules include routines, programs, objects, components, data structures, etc., that perform or implement particular tasks or abstract data types.

### Overview of Discussion

Embodiments of the present technology are for monitoring and detecting events. In various embodiments of the present technology, satellite based position determining systems are coupled with seismic event detectors. The satellite based position determining systems are sensitive enough to detect the movement of the Earth's crust, especially during and after an earthquake. However, limitations of hardware do not allow for large amounts of data to be stored during the normal operation of the satellite based position determining systems when there is not a seismic event taking place or that has taken place in the recent past. Therefore, the satellite based position determining systems is coupled with a seismic event detector. The seismic event detector acts as a trigger to alter the manner in which the position information is stored. Therefore data collected by the satellite based position determining systems before, during and after an event can be treated differently and used for various purposes. One such purpose is to improve the quality and quantity of data to support further analysis.

A discussion of Global Satellite Navigation Systems (GNSSs) and selected positioning techniques will be presented to set the stage for further discussion. An example block diagram of a system for monitoring and detecting an event will then be presented and described. The example system is configured with a Global Navigation Satellite System (GNSS) receiver. Operation of components of this system will then be described in greater detail in conjunction with description of an example method for monitoring and detecting an event. Discussion will proceed to a description of an example computer system environment with which, or upon which, embodiments of the subject matter may operate.

### Global Navigation Satellite Systems

A position determining system may be a Global Navigation Satellite System (GNSS). A GNSS is a navigation system that makes use of a constellation of satellites orbiting the earth to provide signals to a receiver that estimates its position relative to the earth from those signals. Examples of such satellite systems are the NAVSTAR Global Positioning System (GPS) deployed and maintained by the United States, the GLObal NAvigation Satellite System (GLONASS) deployed by the Soviet Union and maintained by the Russian Federation, the GALILEO system currently being deployed by the European Union (EU), and the Compass/Beidou currently being deployed by China. Embodiments of the present technology may make use of the described satellite systems or other position determining systems that may or may not be satellite based systems.

Each GPS satellite transmits continuously using two radio frequencies in the L-band, referred to as L1 and L2, at respective frequencies of 1575.41 MHz and 1227.60 MHz. Two signals are transmitted on L1, one for civil users and the other for users authorized by the Unites States Department of Defense (DoD). One signal is transmitted on L2, intended only for DoD-authorized users. Each GPS signal has a carrier at the L1 and L2 frequencies, a pseudo-random number (PRN) code, and satellite navigation data. Two different PRN codes are transmitted by each satellite: a coarse acquisition (C/A) code and a precision (P/Y) code which is encrypted for use by authorized users. A GPS receiver designed for precision positioning contains multiple channels, each of which can track the signals on both L1 and L2 frequencies from a GPS satellite in view above the horizon at the receiver antenna, and from these computes the observables for that satellite comprising the L1 pseudorange, possibly the L2 pseudorange and the coherent L1 and L2 carrier phases. Coherent phase tracking implies that the carrier phases from two channels assigned to the same satellite and frequency will differ only by an integer number of cycles.

Each GLONASS satellite transmits continuously using two radio frequency bands in the L-band, also referred to as L1 and L2. Each satellite transmits on one of multiple frequencies within the L1 and L2 bands respectively centered at frequencies of 1602.0 MHz and 1246.0 MHz. The code and carrier signal structure is similar to that of NAVSTAR. A GNSS receiver designed for precision positioning contains multiple channels each of which can track the signals from both GPS and GLONASS satellites on their respective L1 and L2 frequencies, and generate pseudorange and carrier phase observables from these. Future generations of GNSS receivers will include the ability to track signals from all deployed GNSSs. It should be noted embodiments in accordance with the present technology are noted limited to use with signals of any particular frequency. For example, embodiments in accordance with the present technology are well suited to use with the L5 frequency of GPS an L5 and any of the several frequencies that GALILEO will employ. Additionally, embodiments in accordance with the present technology are well suited to use with post-processing methodologies. Post-processing methodologies are well-known in the art and collecting data for Post-Processing is one of the major roles of a reference receiver in addition to the creation of RTK correctors.

### Virtual Reference Stations

To achieve very accurate positioning (to several centimeters or less) of a terrestrial mobile platform, relative or differential positioning methods are commonly employed. These methods use a GNSS reference receiver located at a known position, in addition to the data from a GNSS receiver on the mobile platform, to compute the estimated position of the mobile platform relative to the reference receiver. The most accurate known method uses relative GNSS carrier phase interferometery between the GNSS rover receiver and GNSS reference receiver antennas plus resolution of integer wavelength ambiguities in the differential phases to achieve centimeter-level positioning accuracies. These differential GNSS methods are predicated on the near exact correlation of several common errors in the rover and reference observables. They include ionosphere and troposphere signal delay errors, satellite orbit and clock errors, and receiver clock errors.

When the baseline length between the mobile platform and the reference receiver does not exceed 10 kilometers, which is normally considered a short baseline condition, the ionosphere and troposphere signal delay errors in the observables from the rover and reference receivers are almost exactly the same. These atmospheric delay errors therefore cancel in the rover-reference differential GNSS observables, and the carrier phase ambiguity resolution process required for achieving centimeter-level relative positioning accuracy is not perturbed by them. If the baseline length increases beyond 10 kilometers (considered a long baseline condition), these errors at the rover and reference receiver antennas become increasingly different, so that their presence in the rover-reference differential GNSS observables and their influence on the ambiguity resolution process increases. Ambiguity resolution on single rover-reference receiver baselines beyond 10 kilometers becomes increasingly unreliable. This attribute limits the precise resolution of a mobile platform with respect to a single reference receiver, and essentially makes it unusable on a mobile mapping platform that covers large distances as part of its mission, such as an aircraft.

A network GNSS method computes the estimated position of a rover receiver using reference observables from three or more reference receivers that approximately surround the rover receiver trajectory. This implies that the rover receiver trajectory is mostly contained by a closed polygon whose vertices are the reference receiver antennas. The rover receiver can move a few kilometers outside this polygon without significant loss of positioning accuracy. A network GNSS algorithm calibrates the ionosphere and troposphere signal delays at each reference receiver position and then interpolates and possibly extrapolates these to the rover position to achieve better signal delay cancellation on long baselines than could be had with a single reference receiver. Various methods of signal processing can be used, however they all yield essentially the same performance improvement on long baselines. As with single baseline GNSS, previously known GNSS solutions are still inadequate for a mobile platform that covers large distances as part of its mission, such as an aircraft or a Low Earth Orbit (LEO) satellite.

Kinematic ambiguity resolution (KAR) satellite navigation is a technique used in numerous applications requiring high position accuracy. KAR is based on the use of carrier phase measurements of satellite positioning system signals, where a single reference station provides the real-time corrections with high accuracy. KAR combines the L1 and L2 carrier phases from the rover and reference receivers so as to establish a relative phase interferometry position of the rover antenna with respect to the reference antenna. A coherent L1 or L2 carrier phase observable can be represented as a precise pseudorange scaled by the carrier wavelength and biased by an integer number of unknown cycles known as cycle ambiguities. Differential combinations of carrier phases from the rover and reference receivers result in the cancellation of all common mode range errors except the integer ambiguities. An ambiguity resolution algorithm uses redundant carrier phase observables from the rover and reference receivers, and the known reference antenna position, to estimate and thereby resolve these ambiguities.

Once the integer cycle ambiguities are known, the rover receiver can compute its antenna position with accuracies generally on the order of a few centimeters, provided that the rover and reference antennas are not separated by more than 10 kilometers. This method of precise positioning performed in real-time is commonly referred to as real-time kinematic (RTK) positioning.

The reason for the rover-reference separation constraint is that KAR positioning relies on near exact correlation of atmospheric signal delay errors between the rover and reference receiver observables, so that they cancel in the rover-reference observables combinations (for example, differences between rover and reference observables per satellite). The largest error in carrier-phase positioning solutions is introduced by the ionosphere, a layer of charged gases surrounding the earth. When the signals radiated from the satellites penetrate the ionosphere on their way to the ground-based receivers, they experience delays in their signal travel times and shifts in their carrier phases. A second significant source of error is the troposphere delay. When the signals radiated from the satellites penetrate the troposphere on their way to the ground-based receivers, they experience delays in their signal travel times that are dependent on the temperature, pressure and humidity of the atmosphere along the signal paths. Fast and reliable positioning requires good models of the spatio-temporal correlations of the ionosphere and troposphere to correct for these non-geometric influences.

When the rover-reference separation exceeds 10 kilometers, as is the typical case with a LEO satellite GNSS rover receiver, the atmospheric delay errors become decorrelated and do not cancel exactly. The residual errors can now interfere with the ambiguity resolution process and thereby make correct ambiguity resolution and precise positioning less reliable.

The rover-reference separation constraint has made KAR positioning with a single reference receiver unsuitable for certain mobile positioning applications where the mission of the mobile platform will typically exceed this constraint. One solution is to set up multiple reference receivers along the mobile platform's path so that at least one reference receiver falls within a 10 km radius of the mobile platform's estimated position. This approach can become time-consuming and expensive if the survey mobile platform covers a large project area. It can also be impractical or impossible if the mobile platform is operated at a high altitude, such as a LEO satellite is.

Network GNSS methods using multiple reference stations of known location allow correction terms to be extracted from the signal measurements. Those corrections can be interpolated to all locations within the network. Network KAR is a technique that can achieve centimeter-level positioning accuracy on large project areas using a network of reference GNSS receivers. This technique operated in real-time is commonly referred to as network RTK. The network KAR algorithm combines the pseudorange and carrier phase observables from the reference receivers as well as their known positions to compute calibrated spatial and temporal models of the ionosphere and troposphere signal delays over the project area. These calibrated models provide corrections to the observables from the rover receiver, so that the rover receiver can perform reliable ambiguity resolution on combinations of carrier phase observables from the rover and some or all reference receivers. The number of reference receivers required to instrument a large project area is significantly less than what would be required to compute reliable single baseline KAR solutions at any point in the project area. See, for example, U.S. Pat. No. 5,477,458, “Network for Carrier Phase Differential GPS Corrections,” and U.S. Pat. No. 5,899,957, “Carrier Phase Differential GPS Corrections Network”. See also Liwen Dai et al., “Comparison of Interpolation Algorithms in Network-Based GPS Techniques,” Journal of the Institute of Navigation, Vol. 50, No. 4 (Winter 2003-2004) for a comparison of different network GNSS implementations and comparisons of their respective performances.

A virtual reference station (VRS) network method is a particular implementation of a network GNSS method that is characterized by the method by which it computes corrective data for the purpose of rover position accuracy improvement. A VRS network method comprises a VRS corrections generator and a single-baseline differential GNSS position generator such as a GNSS receiver with differential GNSS capability. The VRS corrections generator has as input data the pseudorange and carrier phase observables on two or more frequencies from N reference receivers, each tracking signals from M GNSS satellites. The VRS corrections generator outputs a single set of M pseudorange and carrier phase observables that appear to originate from a virtual reference receiver at a specified position (hereafter called the VRS position) within the boundaries of the network defined by a polygon (or projected polygon) having all or some of the N reference receivers as vertices. The dominant observables errors comprising a receiver clock error, satellite clock errors, ionosphere and troposphere signal delay errors and noise all appear to be consistent with the VRS position. The single-baseline differential GNSS position generator implements a single-baseline differential GNSS position algorithm, of which numerous examples have been described in the literature. B. Hofmann-Wellenhof et al., Global Positioning System: Theory and Practice, 5th Edition, 2001 (hereinafter “Hofmann-Wellenhof [2001]”), gives comprehensive descriptions of different methods of differential GNSS position computation, ranging in accuracies from one meter to a few centimeters. The single-baseline differential GNSS position algorithm typically computes differences between the rover and reference receiver observables to cancel atmospheric delay errors and other common mode errors such as orbital and satellite clock errors. The VRS position is usually specified to be close to or the same as the roving receiver's estimated position so that the actual atmospheric errors in the roving receiver's observables approximately cancel the estimated atmospheric errors in the VRS observables in the rover-reference observables differences.

The VRS corrections generator computes the synthetic observables at each sampling epoch (typically once per second) from the geometric ranges between the VRS position and the M satellite positions as computed using well-known algorithms such as given in “Naystar GPS Space Segment/Navigation User Interface,” ICD-GPS-200C-005R1, 14 Jan. 2003 (hereinafter “ICD-GPS-200”). It estimates the typical pseudorange and phase errors comprising receiver clock error, satellite clock errors, ionosphere and tropospheric signal delay errors and noise, applicable at the VRS position from the N sets of M observables generated by the reference receivers, and adds these to the synthetic observables.

A network RTK system operated in real time requires each GNSS reference receiver to transmit its observables to a network server computer that computes and transmits the corrections and other relevant data to the GNSS rover receiver. The GNSS reference receivers, plus hardware to assemble and broadcast observables, are typically designed for this purpose and are installed specifically for the purpose of implementing the network. Consequently, those receivers are called dedicated (network) reference receivers.

An example of a VRS network is designed and manufactured by Trimble Navigation Limited, of Sunnyvale, Calif. The VRS network as delivered by Trimble includes a number of dedicated reference stations, a VRS server, multiple server-reference receiver bi-directional communication channels, and multiple server-rover bi-directional data communication channels. Each server-rover bi-directional communication channel serves one rover. The reference stations provide their observables to the VRS server via the server-reference receiver bi-directional communication channels. These channels can be implemented by a public network such as the Internet. The bi-directional server-rover communication channels can be radio modems or cellular telephone links, depending on the location of the server with respect to the rover.

The VRS server combines the observables from the dedicated reference receivers to compute a set of synthetic observables at the VRS position and broadcasts these plus the VRS position in a standard differential GNSS (DGNSS) message format, such as one of the RTCM (Radio Technical Commission for Maritime Services) formats, an RTCA (Radio Technical Commission for Aeronautics) format or a proprietary format such as the CMR (Compact Measurement Report) or CMR+ format which are messaging system communication formats employed by Trimble Navigation Limited. Descriptions for numerous of such formats are widely available. For example, RTCM Standard 10403.1 for DGNSS Services—Version 3, published Oct. 26, 2006 (and Amendment 2 to the same, published Aug. 31, 2007) is available from the Radio Technical Commission for Maritime Services, 1800 N. Kent St., Suite 1060, Arlington, Va. 22209. The synthetic observables are the observables that a reference receiver located at the VRS position would measure. The VRS position is selected to be close to the rover's estimated position so that the rover-VRS separation is less than a maximum separation considered acceptable for the application. Consequently, the rover receiver must periodically transmit its approximate position to the VRS server. The main reason for this particular implementation of a real-time network RTK system is compatibility with RTK survey GNSS receivers that are designed to operate with a single reference receiver.

Descriptions of the VRS technique are provided in U.S. Pat. No. 6,324,473 of (hereinafter “Eschenbach”) (see particularly col. 7, line 21 et seq.) and U.S. Patent application publication no. 2005/0064878, of B. O'Meagher (hereinafter “O'Meagher”), which are assigned to Trimble Navigation Limited; and in H. Landau et al., Virtual Reference Stations versus Broadcast Solutions in Network RTK, GNSS 2003 Proceedings, Graz, Austria (2003); each of which is incorporated herein by reference.

The term “VRS”, as used henceforth in this document, is used as shorthand to refer to any system or technique which has the characteristics and functionality of VRS described or referenced herein and is not necessarily limited to a system from Trimble Navigation Ltd. Hence, the term “VRS” is used in this document merely to facilitate description and is used without derogation to any trademark rights of Trimble Navigation Ltd. or any subsidiary thereof or other related entity.

### Embodiments

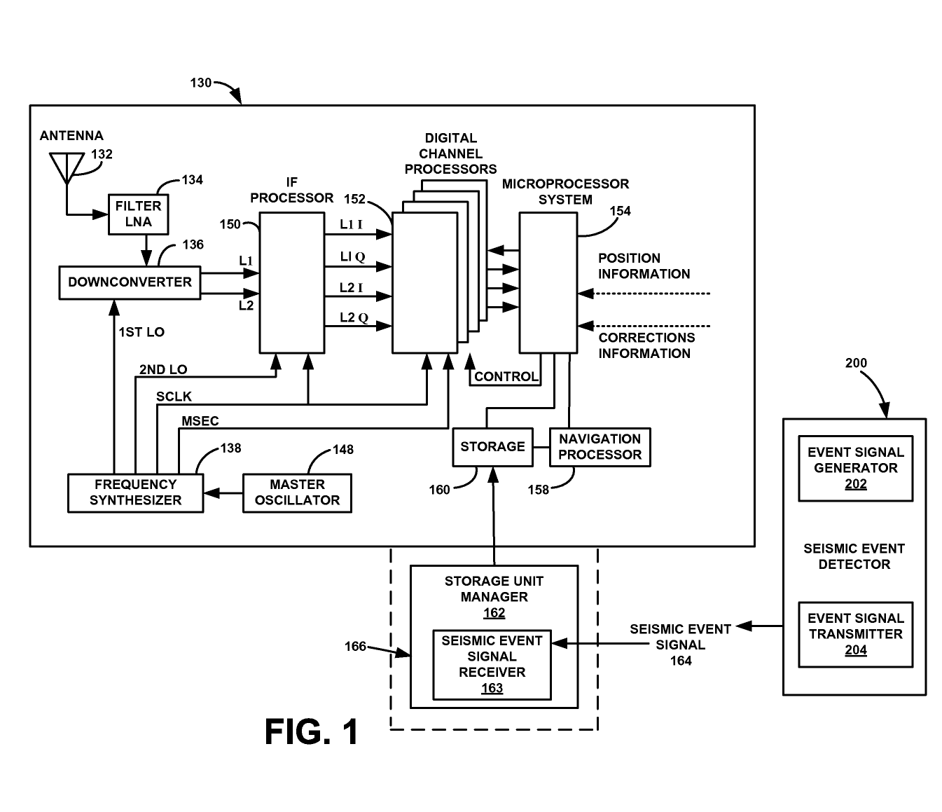

With reference now to FIG. 1, a block diagram is shown of an embodiment of an example GNSS receiver which may be used in accordance with various embodiments described herein. In particular, FIG. 1 illustrates a block diagram of a GNSS receiver in the form of a general purpose receiver 130 capable of demodulation of the L1 and/or L2 signal(s) received from one or more GPS satellites. A more detailed discussion of the function of a receiver such as receiver 130 can be found in U.S. Pat. No. 5,621,426. U.S. Pat. No. 5,621,426, by Gary R. Lennen, is titled “Optimized processing of signals for enhanced cross-correlation in a satellite positioning system receiver,” and includes a GPS receiver very similar to receiver 130 of FIG. 1.

In FIG. 1, received L1 and L2 signals are generated by at least one GPS satellite. Each GPS satellite generates different signal L1 and L2 signals and they are processed by different digital channel processors 152 which operate in the same way as one another. FIG. 1 shows GPS signals (L1=1575.42 MHz, L2=1227.60 MHz) entering receiver 130 through a dual frequency antenna 132. Antenna 132 may be a magnetically mountable model commercially available from Trimble Navigation of Sunnyvale, Calif. Master oscillator 148 provides the reference oscillator which drives all other clocks in the system. Frequency synthesizer 138 takes the output of master oscillator 148 and generates important clock and local oscillator frequencies used throughout the system. For example, in one embodiment frequency synthesizer 138 generates several timing signals such as a 1st (local oscillator) signal LO1 at 1400 MHz, a 2nd local oscillator signal LO2 at 175 MHz, an SCLK (sampling clock) signal at 25 MHz, and a MSEC (millisecond) signal used by the system as a measurement of local reference time.

A filter/LNA (Low Noise Amplifier) 134 performs filtering and low noise amplification of both L1 and L2 signals. The noise figure of receiver 130 is dictated by the performance of the filter/LNA combination. The downconvertor 136 mixes both L1 and L2 signals in frequency down to approximately 175 MHz and outputs the analogue L1 and L2 signals into an IF (intermediate frequency) processor 150. IF processor 150 takes the analog L1 and L2 signals at approximately 175 MHz and converts them into digitally sampled L1 and L2 inphase (L1 I and L2 I) and quadrature signals (L1 Q and L2 Q) at carrier frequencies 420 KHz for L1 and at 2.6 MHz for L2 signals respectively.

At least one digital channel processor 152 inputs the digitally sampled L1 and L2 inphase and quadrature signals. All digital channel processors 152 are typically are identical by design and typically operate on identical input samples. Each digital channel processor 152 is designed to digitally track the L1 and L2 signals produced by one satellite by tracking code and carrier signals and to from code and carrier phase measurements in conjunction with the microprocessor system 154. One digital channel processor 152 is capable of tracking one satellite in both L1 and L2 channels. Microprocessor system 154 is a general purpose computing device (such as computer system 400 of FIG. 4) which facilitates tracking and measurements processes, providing pseudorange and carrier phase measurements for a navigation processor 1158. In one embodiment, microprocessor system 154 provides signals to control the operation of one or more digital channel processors 152. Navigation processor 158 performs the higher level function of combining measurements in such a way as to produce position, velocity and time information for the differential and surveying functions. Storage 160 is coupled with navigation processor 158 and microprocessor system 154. It is appreciated that storage 160 may comprise a volatile or non-volatile storage. Storage 160 is a storage unit that may comprise RAM, ROM, flash memory, a hard disk drive, magnetic tape or some other computer readable memory device or storage media. In one rover receiver embodiment, navigation processor 158 performs one or more of the methods of position correction described herein. For example, in one rover receiver embodiment, navigation processor 158 utilizes a received VRS corrected LEO satellite position to refine a position determined by receiver 130.

In some embodiments, such as in rover receivers, microprocessor 154 and/or navigation processor 158 receive additional inputs for use in refining position information determined by receiver 130. For example, in one embodiment LEO satellite position information, such as information regarding a VRS corrected LEO satellite position estimate, is received and used as an input. Such LEO satellite position information is received in one embodiment via a coupling to a LEO satellite receiver. Additionally, in some embodiments, corrections information is received and utilized. Such corrections information can include differential GPS corrections, RTK corrections, signals used by the previously referenced Enge-Talbot method; and wide area augmentation system (WAAS) corrections.

FIG. 1 also includes system 166, storage unit manager 162, seismic event signal receiver 163, seismic event signal 164, seismic event detector 200, event signal generator 202, and event signal transmitter 204. It should be appreciated that receiver 130 may include some, all or none of the components depicted in FIG. 1.

In one embodiment, receiver 130 is an independent unit that is optionally coupled with system 166 for purposes of the present technology. In one embodiment, receiver 130 is built is such a way as to include the components of system 166. In one embodiment, receiver 130 is a position determining unit.

In one embodiment, receiver 130 is capable of determining its position on the surface of the Earth with accuracy measured in fraction of a millimeter. In one embodiment, this accuracy is accomplished by using RTK corrections and by leaving receiver 130 in a stationary position for a comparatively long period of time. Such a technique may be referred to as “baking.” This may be accomplished by anchoring receiver 130 to the Earth or by anchoring receiver 130 to a massive object on the surface of the Earth.

In one embodiment, receiver 130 is capable of being connected to different unique antennas. Each antenna may be a different make and model. In one embodiment, each antenna will store a unique antenna model and transmit this to receiver 130 upon request. Thus allowing receiver 130 to achieve greater accuracy for a given receiver and antenna combination.

In one embodiment, receiver 130 is capable of measuring the movement of the Earth with respect to itself. For example, receiver 130 may be operating during a seismic event such as an earthquake. During the earthquake the tectonic plate that receiver 130 is operating on may have moved with respect to surrounding tectonic plates. In such an example, receiver 130 may be able to detect the movement of the tectonic plate.

It should be appreciated that receiver 130 is capable of logging data at various sample rates. In one embodiment, receiver 130 logs data at a rate of one position fix sample per a second. In one embodiment, receiver 130 logs data at a rate of twenty position fix samples per a second. Such data may be stored in storage 160. Because of hardware limitations, it is not desirable for receiver 130 to log data a high sample rate on a regular basis. Moreover, data logged at a higher sample rate requires greater storage capacity. In the regular operation of receiver 130, not all data is valuable or desirable to store on a long term basis. Therefore, techniques are used to sample, log and store data in a manner consistent with the desirability and value of a given data set. It will be understood that data logging is a well-known and widely-used practice for various types of data collection.

It should be appreciated that the rate receiver 130 logs data at a number of position fixes per a second may be referred to as the frequency at which the data is stored. It should also be appreciated that position fix data may also be referred to as position determining data.

In one embodiment, storage 160 stores data in a temporary manner and deletes or overwrites the data after a certain criteria is reached. For example, data may be deleted or overwritten after a predetermined time period has passed. In one embodiment, the manner of storage employed by storage 160 may be altered. In one embodiment, storage 160 is capable of storing data in more than one type of data structure.

In one embodiment, storage 160 comprises a ring buffer. In one embodiment, normal operations of receiver 130 will log data at a sample rate of one position fix per a second in the ring buffer. Once the ring buffer has reached full capacity, receiver 130 will replace or overwrite the oldest data with the newest data. In one embodiment, storing data in this fashion may be referred to as a first manner. This technique allows for a temporary storage of data without requiring the need for storage capacities that will accommodate long term storage of large amounts of data. If the data stored in the ring buffer is determined to be valuable, the data can be transferred to long term storage either within storage 160 or to a different location. Alternatively, the ring buffer can be altered to replace, overwrite or delete old data.

In one embodiment, storage unit manager 162 is capable of altering the manner in which data is stored in storage 160. For example, receiver 130 may be operating in a first manner where data is logged and stored at rate of one position fix per a second in storage 160. Storage unit manager 162 may then alter the first manner so that data is then logged and stored at a rate of twenty position fixes per a second. In one embodiment, storage manager 162 alters the manner of storage when it is activated by a trigger. Such a trigger may be external to receiver 130 or may be a component of receiver 130.

In one embodiment, such a trigger may be seismic event signal 164. Seismic event signal 164 may be received by seismic event signal receiver 163. In one embodiment, seismic event signal may be a wireless signal such as a radio signal. In one embodiment, seismic event signal may be an electronic signal sent over a wire capable of carrying such a signal. It should be appreciated that seismic event signal receiver comprises the hardware necessary to receive seismic event signal 164. In one embodiment, seismic event signal 164 is the trigger that storage unit manager 162 uses to alter the manner of storage at storage 160. In embodiments in accordance with the present technology, the receiver may operate multiple data storage sessions at different frequencies simultaneously. In normal operation, the higher frequency data is discarded by the ring buffer function. One aspect of embodiments in accordance with the present technology is that it causes a portion of this high frequency data from a user-defined period prior to the seismic event to become protected from deletion. This is in addition to protecting the high frequency (20 Hz, for example) data contemporary with the event and following the event. This is also in addition to altering logging settings for data collected following the event.

In one embodiment, seismic event detector 200 is able to detect an event. Such an event may be caused by an earthquake. It should be appreciated that seismic event detector 200 may be any number of devices used to detect events such as an accelerometer, a seismograph, etc. In one embodiment, seismic event detector 200 comprises event signal generator 202 which is capable of generating seismic event signal 164. In one embodiment, seismic event detector 200 comprises event signal transmitter 204 capable of transmitting seismic event signal 164. In one embodiment, event signal transmitter 204 comprises an antenna for transmitting a wireless signal. In one embodiment, event signal transmitter 204 and event signal generator 202 comprise components of a computers system as described in FIG. 4.

In one embodiment, seismic event detector 200 will detect an event, generate seismic event signal 164 at event signal generator 202, and transmit seismic event signal 164 using event signal transmitter 204. Seismic event signal 164 will then be received by seismic event signal receiver 163 and used as a trigger by storage unit manager 162 to alter the manner of storage being employed by receiver 130 at storage 160. For example, receiver 130 may be temporarily storing data at a sample rate of one position fix per a second. During this operation, an earthquake occurs which is detected at seismic event detector 200 which in turns generates and transmits seismic event signal 164 to storage unit manager 162. Storage unit manager 162 then alters the manner of storage at storage 160 to a data sample rate of twenty position fixes per a second, stores this data in long term storage and moves existing data in storage 160 to long term storage. Thus receiver 130 will store data in long term storage both before and after an event and store data at a higher sample rate after the event.

In one embodiment, 1-3 axis of accelerometers are integrated into antenna 132 of receiver 130 to detect short term movement at a rate of 100 samples per a second during an event.

In one embodiment, a traditional seismograph is integrated into the antenna housing of antenna 132 of receiver 130 and will then report its data through receiver 130 to a network control center. In such an embodiment, having a traditional seismograph such as, for example, a physical accelerometer integrated into the GNSS antenna provides important data to validate the GNSS measurements indicating physical motion.

In one embodiment, storage unit manager 162 will alter the manner of storage only for a period of time. Such a period of time may be before, during, or after an event or any combination thereof. For example, storage unit 162 may alter the manner of storage at storage 160 for a period of thirty days following an event. It should be appreciated that this time period is configurable to virtually any amount of time. In one embodiment, seismic event detector is capable of detecting more than one event. In such an embodiment, storage unit manager 162 may be configured to alter the manner of storage at storage 160 for a time period including the more than one events. For example, storage unit manager 160 may be configured to alter the manner of storage for thirty days following an event and on day twenty-five a second event takes place. In this example, storage unit manager 162 may alter the manner of storage for thirty more days after the second event such that the manner of storage was altered for fifty-five consecutive days.

In one embodiment, storage unit manager 162 is capable of altering the manner of storage based on pre-determined settings. In one embodiment, storage unit manager 162 may be configured based on user settings inputted into storage unit manager 162. In one embodiment, user settings inputted into storage unit manager 162 will supersede previous setting including pre-determined settings. In this manner, the manner of storage may be altered on the fly by a user during or after an event.

It should be appreciated that storage unit manager 162 is capable of altering the manner of storage of the data including but not limited to, the structure of the data stored in storage 160, the length of time the data is stored at storage 160, the sample rate that data is stored at storage 160, the redundancy of the data, the location of where the data is stored, if the data is stored in more than one location, etc. In one embodiment, storage unit manager 162 is capable of assigning priority to sets of data in a way that sets of data given priority will not be deleted or overwritten before other sets of data with lower priority. Further, in embodiments in accordance with the present technology the manner of storage may be altered by the receiver 130 (or storage unit manager 162) on the fly according to the preconfigured wishes of the system operator. In one such embodiment, the process is automated, not requiring user intervention.

In one embodiment, seismic event detector 200 will transmit data related to the detection of an event to storage unit manager 162. In one embodiment, storage unit manager 162 will store the data related to the detection of an event at storage 160. In one embodiment, seismic event detector 200 will transmit data related to the detection of an event to different storage location.

In one embodiment, receiver 130 is capable of analyzing the data stored at storage 160 to predict a potential future event. In one embodiment, such analysis will be performed external to receiver 130 using data for receiver 130 as well as data from other receivers collecting similar data. In one embodiment, receiver 130 further comprises a comparison unit for comparing the position determining information with the seismic event information collected by the seismic event detector. In one embodiment, receiver 130 further comprises a reporting unit capable of reporting the position determining information stored in storage 160 to an external unit. In one embodiment, such reporting may be accomplished using radio signals.

In one embodiment, a network of receivers in accordance with embodiments of the present technology is established. The network of receivers also comprises seismographs integrated with a receiver or located independent of a receiver. The network is controlled by a network control center which receives data from all receivers and seismographs in the network. In such an embodiment, during an event such as a earthquake, the network control center may use predictive modeling to predict potential future events such as other earthquakes or associated events such as tsunamis. In one embodiment, the network control center is tied directly to a disaster response system to warn of these potential future events.

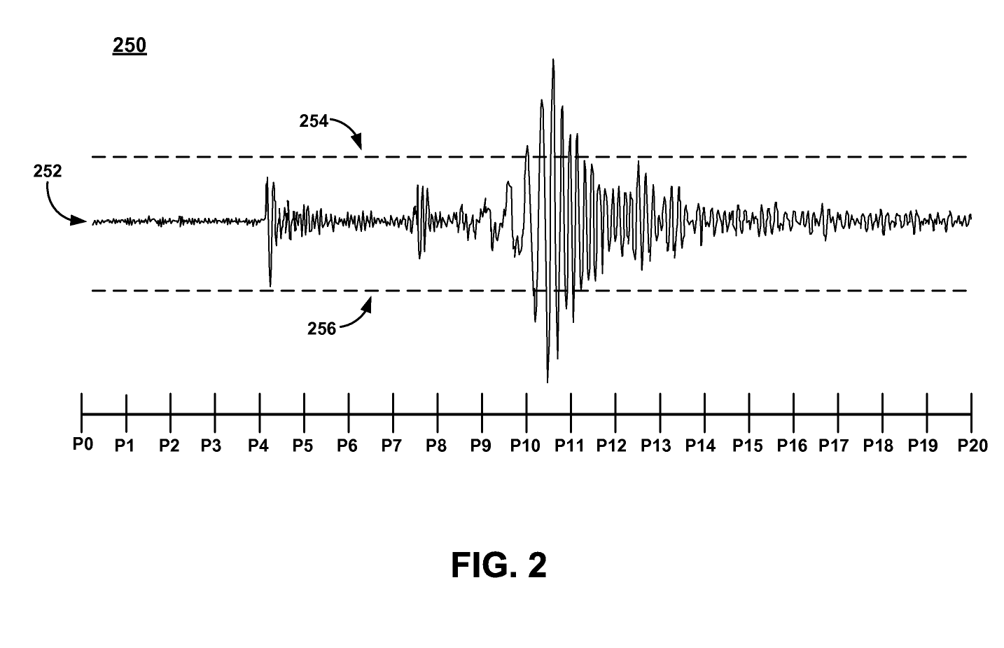

With reference now to FIG. 2, an example graph of a seismic event detector. FIG. 2 comprises graph 252, thresholds 254 and 252, and positions P0-P20. It should be appreciated that FIG. 2 is only an illustration and an actual graph may look different or a seismic event detector may not comprise a graph at all but use a different form of measurement. FIG. 2 is shown to illustrate how measurements taken by a seismic event detector may be used to detect an event.

In one embodiment, graph 252 was made by seismic event detector 200 of FIG. 1. Position P0 is used to demonstrate the beginning of an operation of a seismic event detector and position P20 is used to demonstrate the end of an operation. FIG. 2 is illustrated to demonstrate an event beginning at approximately position P10 and ending at approximately position P11.

In one embodiment, thresholds 254 and 256 are used to determine at what position an event begins and ends. As shown by graph 252, a seismic event detector may experience sensory input that causes fluctuation in the graph. One such large fluctuation is shown in the graph at position P4. Such a fluctuation may not be caused by an event. Thus, only when the graph passes beyond thresholds 254 and 256 is an event detected, and therefore storage unit manager 162 of FIG. 1 is only triggered when the graph passes beyond a threshold. Thresholds 254 and 256 may be adjusted to be more sensitive in detection of an event. For example, thresholds 254 and 256 may be moved closer together so that the fluctuation at P4 would pass beyond the threshold and thus considered an event. The sensitivity of the threshold may be adjusted using well known techniques in the art of building seismic event detectors. In one embodiment, the threshold may be adjusted so that only seismic events of a certain scale or magnitude trigger storage unit manager 162 of FIG. 1.

### Operation

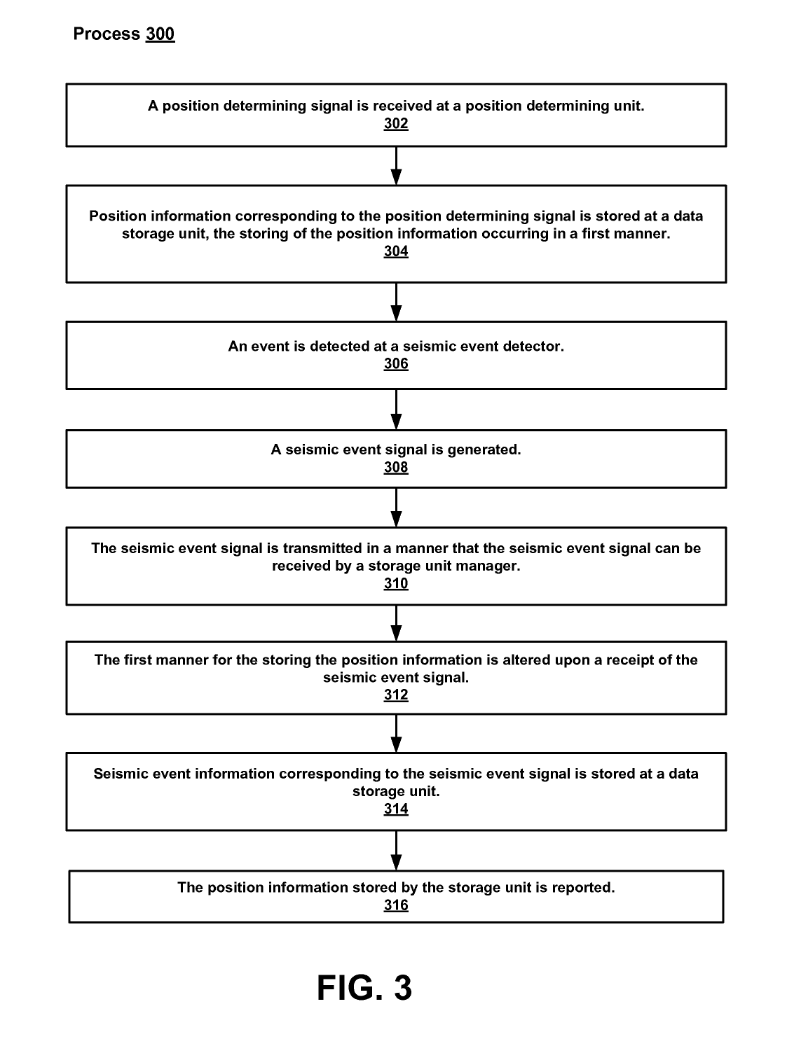

With reference now to FIG. 3, a flowchart of method 300 for monitoring and detecting an event in accordance with embodiments of the present technology. In one embodiment, process 300 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of computer usable storage medium. In one embodiment, process 300 is performed receiver 130, system 166, and seismic event detector 200 of FIG. 1. In one embodiment, the methods may reside in a computer usable storage medium having instructions embodied therein that when executed cause a computer system to perform the method.

It should be appreciated that process 300 may be carried out using some or all of the steps shown in FIG. 3. FIG. 3 depicts an order of stops for purposes of the illustration; the order shown in FIG. 3 should not be construed to limit the present technology.

At 302, a position determining signal is received at a position determining unit. In one embodiment, the position determining signal is satellite based. In one embodiment, position determining unit is receiver 130 coupled with system 166 of FIG. 1.

At 304, position information corresponding to the position determining signal is stored at a data storage unit, the storing of the position information occurring in a first manner. In one embodiment, the data storage unit is storage 160 of FIG. 1.

At 306, an event is detected at a seismic event detector. In one embodiment, the event is a seismic event such as an earthquake. In one embodiment, the seismic event detector is seismic event detector 200 of FIG. 1.

At 308, a seismic event signal is generated. In one embodiment, the seismic event signal is used as a trigger to activate a storage unit manager to alter the storage manner as described at 314. In one embodiment, the seismic event signal is seismic event signal 164 and is generated at event signal generator 202 of FIG. 1.

At 310, the seismic event signal is transmitted in a manner that the seismic event signal can be received by a storage unit manager. In one embodiment, the seismic event signal is transmitted using event signal transmitter 204 of FIG. 1.

At 312, the first manner for the storing the position information is altered upon a receipt of the seismic event signal. In one embodiment, this is accomplished using storage unit manager 162 and storage 160 of FIG. 1 as described above.

At 314, seismic event information corresponding to the seismic event signal is stored at a data storage unit. In one embodiment, the data storage unit is storage 160 of FIG. 1. In one embodiment, the data storage unit is external to receiver 130 of FIG. 1.

At 316, the position information stored by the storage unit is reported. In one embodiment, the position information is reported to a computer system external to receiver 130 of FIG. 1. In one embodiment, the reporting is accomplished using radio transmissions. In one embodiment, the reporting is accomplished using wife.

### Example Computer System Environment

With reference now to FIG. 4, portions of the technology for providing a communication composed of computer-readable and computer-executable instructions that reside, for example, in computer-usable media of a computer system. That is, FIG. 4 illustrates one example of a type of computer that can be used to implement embodiments of the present technology.

FIG. 4 illustrates an example computer system 400 used in accordance with embodiments of the present technology. It is appreciated that system 400 of FIG. 4 is an example only and that the present technology can operate on or within a number of different computer systems including general purpose networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet. A more detailed discussion of the present technology is found below.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described system 400. For example, a method of modifying user interface 225A of device 115A may be applied to operating system 422, applications 424, modules 426, and/or data 428.

System 400 also includes one or more signal generating and receiving device(s) 430 coupled with bus 404 for enabling system 400 to interface with other electronic devices and computer systems. Signal generating and receiving device(s) 430 of the present embodiment may include wired serial adaptors, modems, and network adaptors, wireless modems, and wireless network adaptors, and other such communication technology. The signal generating and receiving device(s) 430 may work in conjunction with one or more communication interface(s) 432 for coupling information to and/or from system 400. Communication interface 432 may include a serial port, parallel port, Universal Serial Bus (USB), Ethernet port, antenna, or other input/output interface. Communication interface 432 may physically, electrically, optically, or wirelessly (e.g. via radio frequency) couple system 400 with another device, such as a cellular telephone, radio, or computer system.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Various example embodiments of the subject matter are thus described. While the subject matter has been described in particular embodiments, it should be appreciated that the subject matter should not be construed as limited by such embodiments, but rather construed according to the following claims. Moreover, while the technology, methods and techniques described above are described with reference to seismic events, it is appreciated that they are also generally applicable to other events.

What is claimed is:

1. A system for monitoring and detecting an event, said system comprising:
a position determining unit configured to receive a position determining signal;
a seismic event detector configured to detect a seismic event and generate a seismic event signal;
a storage unit configured for storing position information corresponding to said position determining signal, said storage of said position information occurs in a first manner; and
a storage unit manager configured to alter said first manner of said storing said position information upon a receipt of said seismic event signal.

2. The position determining system of claim 1 wherein said first manner further comprises a length of time of storage of said position determining information.

3. The position determining system of claim 1 wherein said storage unit further comprises a structure for said storing said positioning determining information.

4. The position determining system of claim 3 wherein said structure for said storing said positioning determining information is altered upon a detection of said event by said seismic event detector.

5. The position determining system of claim 1, further comprising:
a reporting unit configured to report said position determining information stored by said storage unit.

6. The position determining system of claim 1, wherein said position determining signal is a satellite based signal.

7. The position determining system of claim 1 wherein said storage unit manager is further configured to alter said first manner used to store said position determining information for a time period preceding said detection of said event.

8. The position determining system of claim 1 wherein said storage unit manager is further configured to alter said first manner used to store said position determining information for a time period following said detection of said event.

9. The position determining system of claim 1, further comprising:
wherein said seismic event detector is further configured to detect more than one event; and
wherein said storage unit manager is further configured to alter said first manner used to store said position determining information for a time period including said more than one event.

10. The position determining system of claim 1 wherein said first manner further comprises storing said position determining information at a data rate of one position fix sample per a second.

11. The position determining system of claim 1 wherein said storage unit manager is further configured to alter said first manner used to store said position determining information to storing said position determining signal at a data rate of twenty position fix samples per a second upon said detection of said seismic event.

12. The position determining system of claim 1 wherein said a position determining unit is mounted in rigid contact with the Earth and further comprises an antenna configured to receive said position determining signal.

13. The position determining system of claim 1 wherein said storage unit manager is further configured to alter said first manner to store information outputted from said seismic event detector upon said detection of said seismic event.

14. A system for monitoring and detecting an event, said system comprising:
a position determining unit configured to receive a position determining signal;
a storage unit configured for storing position information corresponding to said position determining signal, said storage of said position information occurs in a first manner; and
a storage unit manager configured to alter said first manner of said storing said position information upon a receipt of a seismic event signal, further comprising;
a seismic event signal receiver configured to receive a seismic event signal.

15. The position determining system of claim 14 wherein said first manner further comprises a length of time of storage of said position determining information.

16. The position determining system of claim 14, further comprising:
a reporting unit configured to report said position determining information stored by said storage unit upon a receipt of said seismic event signal.

17. The position determining system of claim 14, wherein said position determining signal is a satellite based signal.

18. The position determining system of claim 14 wherein said storage unit manager is further configured to alter said first manner used to store said position determining information for a time period preceding said receipt of said seismic event signal.

19. The position determining system of claim 14 wherein said storage unit manager is further configured to alter said first manner used to store said position determining information for a time period following said receipt of said seismic event signal.

20. The position determining system of claim 14 wherein said first manner further comprises storing said position determining information at a data rate of one position fix sample per a second.

21. The position determining system of claim 14 wherein said storage unit manager is further configured to alter said first manner used to store said position determining information to storing said position determining signal at a data rate of twenty position fix samples per a second upon said receipt of said seismic event signal.

22. A system for monitoring and detecting an event, said system comprising:
a seismic event detector configured to detect a seismic event;
a seismic event signal generator configured to generate a seismic event signal for controlling a storage unit manager; and
a seismic event signal transmitter configured to transmit said seismic event signal to said storage unit manager.

23. The position determining system of claim 22 wherein said seismic event detector is further configured to detect more than one event.

24. The position determining system of claim 22, further comprising:
a storage unit configured to store said seismic event information corresponding to said seismic event signal.

25. A method for monitoring and detecting events, said method comprising:
receiving a position determining signal at a position determining unit;
storing position information corresponding to said position determining signal at a data storage unit, said storing of said position information occurring in a first manner;
detecting an event at a seismic event detector;
generating a seismic event signal; and
altering said first manner for said storing said position information upon a receipt of said seismic event signal.

26. The method of claim 25 wherein said altering said first manner for said storing said position information further comprises altering said first manner for a period of time preceding said detecting said event.

27. The method of claim 25 wherein said altering said first manner for said storing said position information further comprises altering said first manner for a period of time following said detecting said event.

28. The method of claim 25, further comprising:
wherein said detecting said event comprises more than one event; and
wherein said altering said first manner for said storing said position information further comprises storing said position information for a time period including said more than one event.

29. The method of claim 25 further comprising:
reporting said position information stored by said storage unit.

30. The method of claim 25 further comprising:
storing seismic event information corresponding to said seismic event signal at a data storage unit.

31. A method for monitoring and detecting events, said method comprising:
receiving a position determining signal at a position determining unit;
storing position information corresponding to said position determining signal at a data storage unit, said storing of said position information occurring in a first manner; and
upon receipt of a seismic event signal, altering said first manner for said storing said position information.

32. The method of claim 31 wherein said altering said first manner for said storing said position information further comprises altering said first manner for a period of time preceding said detecting said event.

33. The method of claim 31 wherein said altering said first manner for said storing said position information further comprises altering said first manner for a period of time following said detecting said event.

34. The method of claim 31 further comprising:
reporting said position information stored by said storage unit.

35. A method for monitoring and detecting events, said method comprising:
detecting an event at a seismic event detector;
generating a seismic event signal; and
transmitting said seismic event signal in a manner that said seismic event signal can be received by a storage unit manager.

36. The method of claim 35 further comprising:
storing seismic event information corresponding to said seismic event signal at a data storage unit.
